(19) United States
(12) Patent Application Publication
(10) Pub. No.: US 2022/0193776 A1
(43) Pub. Date: Jun. 23, 2022

(54) HYBRID PROCESSING OF FREEFORM DEPOSITION MATERIAL BY PROGRESSIVE FORGING

(71) Applicant: Divergent Technologies, Inc., Los Angeles, CA (US)

(72) Inventors: Narender Shankar Lakshman, Hermosa Beach, CA (US); Michael Thomas Kenworthy, Rancho Palos Verdes, CA (US)

(21) Appl. No.: 17/548,095

(22) Filed: Dec. 10, 2021

Related U.S. Application Data
(60) Provisional application No. 63/127,734, filed on Dec. 18, 2020.

(51) Int. Cl. B22F 10/50; B22F 10/25; B22F 10/85; B23K 26/342

(52) U.S. Cl. CPC B22F 10/50; B22F 10/25; B33Y 10/00; B23K 26/342; B22F 10/85

(57) ABSTRACT

Aspects are provided for additively manufacturing a component based on direct energy deposition (DED). An apparatus may include a DED system configured to additively manufacture a part. The apparatus may further include a forging tool configured to forge a region of the part during the additive manufacturing. In various embodiments, a solid body is used opposite to the forging tool during the forgery. For example, the solid body may include a mandrel against which the region of the part is forged.

### CROSS-REFERENCE TO RELATED APPLICATION

This application claims the benefit of, and right to priority to, U.S. Provisional Patent Application No. 63/127,734 filed on Dec. 18, 2020 and entitled “Hybrid Processing of Freeform Deposition Material For Enhanced Mechanical Properties By Progressive Forging”, the contents of which are incorporated by reference as if fully set forth herein.

### BACKGROUND

### Field

The present disclosure relates generally to directed energy deposition (DED) systems, and more particularly, to in-situ forging in DED systems.

### Background

Additive manufacturing (AM) has provided a significant evolutionary step in the development and manufacture of vehicles, aircraft, spacecraft, and other transport structures. One example of an AM system is DED. DED systems can produce parts with geometrically complex shapes, including some shapes that are difficult or impossible to create with conventional manufacturing processes. DED systems can create parts layer by layer. Each layer is formed by processing raw material such as wire or powder and melting the raw material to deposit a layer of the material with an energy beam source. The melted wire or powder cools and fuses to form a layer of the part. Each layer is deposited on top of the previous layer, as the part is manufactured layer-by-layer from the ground up. DED can also be used for adding features to parts built using other techniques.

DED has been known to produce various artifacts, including rough surfaces, loosely bonded layers, inclusions and other defects that can lead to cracks and even premature part failure. While fixes can be attempted in post-processing, the defects may be out of reach, or the fixes time-consuming. This may prove more problematic, for example, if isotropy of the part is an important consideration, such as in parts used for bearing multiple loads from different directions. A need exists for providing more versatility to DED to expand its capabilities for future applications.

### SUMMARY

Several aspects of apparatuses and methods for improving the quality and versatility of DED-based processes in additive manufacturing will be described more fully hereinafter.

In various aspects, a method includes additively manufacturing a part by DED, and forging, during the additive manufacturing, a region of the part.

In various aspects, an apparatus includes a directed energy deposition (DED) system configured to additively manufacture a part; and a forging tool configured to forge a region of the part during the additive manufacturing.

Other aspects will become readily apparent to those skilled in the art from the following detailed description, wherein is shown and described only several embodiments by way of illustration. As will be realized by those skilled in the art, concepts herein are capable of other and different embodiments, and several details are capable of modification in various other respects, all without departing from the present disclosure. Accordingly, the drawings and detailed description are to be regarded as illustrative in nature and not as restrictive.

### BRIEF DESCRIPTION OF THE DRAWINGS

Various aspects of will now be presented in the detailed description by way of example, and not by way of limitation, in the accompanying drawings, wherein:

FIG. 1 is a conceptual diagram illustrating an example wire DED system.

FIG. 2 is a conceptual diagram illustrating an example powder DED system.

FIG. 3 is a diagram illustrating in-situ forging of a part being additively manufactured using DED.

FIG. 4 is a conceptual diagram illustrating a progression of freeform print material into a solid structure during an in-situ forging process with DED.

FIG. 5 is a top-down diagram of an example part being forged with a roller-based forging tool.

FIGS. 6A-B are cross-sectional views of a region of an additively manufactured part being forged using a combination of forging tools and a fixed structure.

FIG. 7 is an exemplary flow diagram of a method for additive manufacturing using DED while concurrently forging the part.

FIG. 8 is a side view of an exemplary positioning system using robots for manipulating forging of a part during a DED process.

### DETAILED DESCRIPTION

The detailed description set forth below in connection with the appended drawings is intended to provide a description of various exemplary embodiments of the concepts disclosed herein and is not intended to represent the only embodiments in which the disclosure may be practiced. The term “exemplary” used in this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, in order to avoid obscuring the various concepts presented throughout this disclosure.

Being non-design specific, AM is capable of enabling construction of an almost unlimited variety of structures having diverse geometrical shapes and material characteristics. DED can provide these structures using a variety of materials, including alloys.

In a DED system, a part may be additively manufactured by using an energy source to provide heat sufficient to fuse a layer of material onto the part while the layer is being deposited. The deposited material thereafter cools until it solidifies, and the process is repeated layer-by-layer until the build piece is fully manufactured. As noted, additive manufacturing provides great flexibility in manufacturing custom geometries, which are generally modeled from an input CAD file. However, additive manufacturing may also cause defects to be formed on the build piece, resulting in stress concentrations, inclusions, and poor inter-layer adhesion. Such defects may adversely impact both the performance and the aesthetics of the part.

Aspects of the present disclosure include apparatuses and methods for improving the quality of freeform additively manufactured parts during DED. One such technique includes the in-situ application of forging loads to forge regions of the part during the additive manufacturing process. Forging the part during DED, while the layers of the part are subject to the initial thermal gradients, can enhance both the geometric characteristics of the part and its mechanical properties. In addition, forging regions of the part while the part is concurrently being additively manufactured means that the forged regions experience significant stresses prior to cooling down from irradiation by the energy beam. These stresses may include downward pressures applied generally orthogonal to the build plate. These downward forces can directly oppose the layered architecture of the DED, causing the layers to press into each other and become homogenous with each other. Because forging is performed in-situ, this homogenization of the layers can beneficially be performed during the time the temperature is sufficiently heightened due to the irradiation of the layers from the DED energy source. The heightened temperature, in addition to fusing the layers for DED, also renders the layers sufficiently malleable to integrate them together through application of forging forces. Thus, in-situ forging can promote inter-layer adhesion, the absence of which has been a persistent problem in the art with additively manufactured designs.

The downward forces, as well as sideways forces applied against a side of the part using a mandrel adjacent a region being formed can remove print defects during the DED process such as inclusions, shuts, laps, or part misalignments, among others. In-situ forging, or forging the material as it is being deposited on the DED part, can also improve problems in the print with inter-layer adhesion. For example, during a normal DED process, oxides or inclusions can be formed between the layers, further decreasing the adhesion of the layers. One benefit of progressively forging the material during the DED process is that the application of the forging forces can correct these defects as they occur by forcing the layers into contact.

The positioning of the mandrel may depend on the shape of the part. In a hollow cylinder, for example, the mandrel may be in the part's interior adjacent the wall being forged. The mandrel may in other configurations be exterior to the forged region, such as when the region is a solid body. The sudden pounding and pressing of the malleable print material at the elevated temperature can cause the part, or desired regions within the part, to become isotropic and homogenous in nature such that the mechanical properties of the part become substantially identical in any direction within the region. This property may be crucial for specific applications. Also, unwanted gaps or pores in the deposited and fused print material can be removed during the print using the forging forces. Misalignments in an irradiated layer with a layer below it can be brought into alignment using the forging tools. Unintended ledges and bumps in regions of the fused material can similarly be corrected and removed using forging.

As the DED process and the irradiation by the energy source continues in a conventional implementation without forging, the gaps and pores can generally be driven deeper into the material, making post-processing fixes increasingly difficult to achieve. Even if the trapped pores or gaps are seen, they may not be reachable once the additive manufacturing process is complete. These artifacts can also result in fine cracks in the part that may be difficult to localize. The embodiments disclosed herein can eliminate these problems, or reduce them substantially, through the use of in-situ forging.

While correction of print defects is an important consideration which is addressed by the principles herein, in-situ forging can be equally appropriate when motivated by a desire to change the part geometry in real time. In addition to correcting defects on the fly, concurrent forging of the part can introduce a new versatility to DED manufacturing processes by enabling on-the-fly changes in part geometry. Forging tools do not merely increase homogeneity of the printed piece and remove defects, but can change the geometry and shape of the part, or regions thereof, to implement different designs. For example, forging can be used to press or fold metallic regions in specific geometrical directions while concurrently providing these new geometries with desirable attributes such as increased density and strength beyond the capabilities of the energy beam alone. In various embodiments, the designer may produce a CAD file that demonstrates how the part should be assembled. The designer may produce additional files that represent design variations of the printed part when concurrently manipulated by a forging process. In various embodiments, this process may be automated in part or in whole.

The desired part may depend on a large number of factors, including the base geometry of the part undergoing DED (e.g., whether a portion or all of the printed part is solid or hollow), the type and complexity of modifications desired, the type of print material is being used, and the types of geometrical or mechanical changes that are possible in practice with the available forging tools. In various embodiments, the forging tools are designed to incorporate geometrical shapes that are conducive to realizing the desired part. For example, a mandrel be curved to match the desired curvature of the part when forging is applied. Similarly, in various embodiments, the forging may rely on a mandrel that is custom-designed to accommodate the geometry of the DED part. A mandrel may in some embodiments include a blunt instrument that is shaped in a desired shape of the part.

In some exemplary embodiments, if the part is solid, the forging tools may apply forces during DED without using a mandrel. The forging tools may instead depend on a local internal solidified region of the part to apply reactive forces when the part is being forged. This internal solidified region, by virtue of it being a region within the part, applies an outward force via inter-molecular dynamics to counteract the inward applied forging force (or conversely, an upward force to counteract the downward force) in order to properly shape the part as desired. In other embodiments, the printed part may be partially hollow. If a commercial-off-the-shelf (COTS) mandrel is not available with a shape that fits in these cases, a custom mandrel may be 3-D printed.

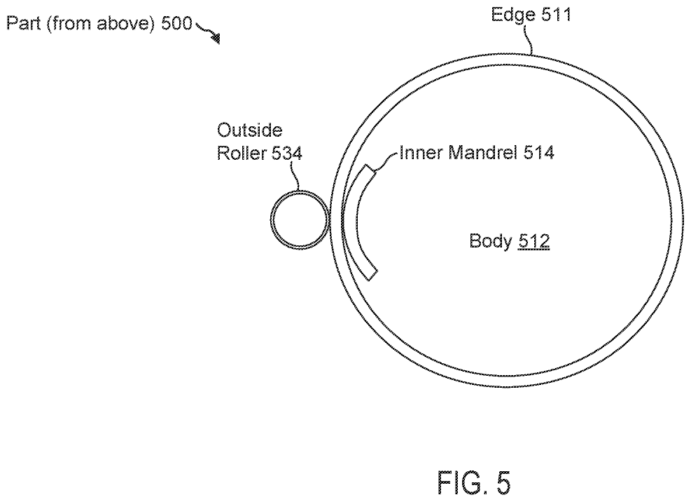

During DED, the forging instruments can apply their respective forces to the part when the mandrel is positioned against the part on the other side (FIG. 5). Thus the forging can shape the material to comport with the shape of the mandrel. Depending on the print material used, the mechanical properties of the material subject to the forging pressures may differ from the properties of the remainder of the part. These differences may be an intended portion of the overall part design. In some examples, the forging may be used to increase the density and isotropic character of the part being printed, and to remove defects, rather than to fundamentally change geometries. The effects achieved from the in-situ forging can be governed by different factors including the magnitude and direction of the applied forging forces, the timing of these forces in relation to the measured temperature gradients, the geometry of the mandrel, and the physical or chemical composition of the print material, to name a few. For example, when material is deposited and welded using DED, the apparent strength in the vertical (z) direction is less than the strength of the material in the horizontal (x-y) direction, since the layers are initially not bonded when they are laid over one another. Progressive forging in-situ can squeeze the layers together vertically by the complementary applications of force, and thus can make the material isotropic.

The same application of forces can make new shapes. That is, the combination of forging the part while concurrently building the part with DED can produce new geometries having material properties that can be selectively manipulated to produce different mechanical properties where needed. Forging can add considerable strength to the part. The temperature-elevated material can be stretched, flattened, folded, and manipulated in specific desired ways to achieve a variety of new part designs. Overall, in addition to its ability to correct defects, the forging process may add significant versatility to the DED process by allowing the designer to modify the shape and geometry of the part as well as reinforce the part in specific areas. Forging can also be used in limited regions of a part where superior mechanical properties may be needed, such as in applications involving heavy machinery, transport structures, and the like.

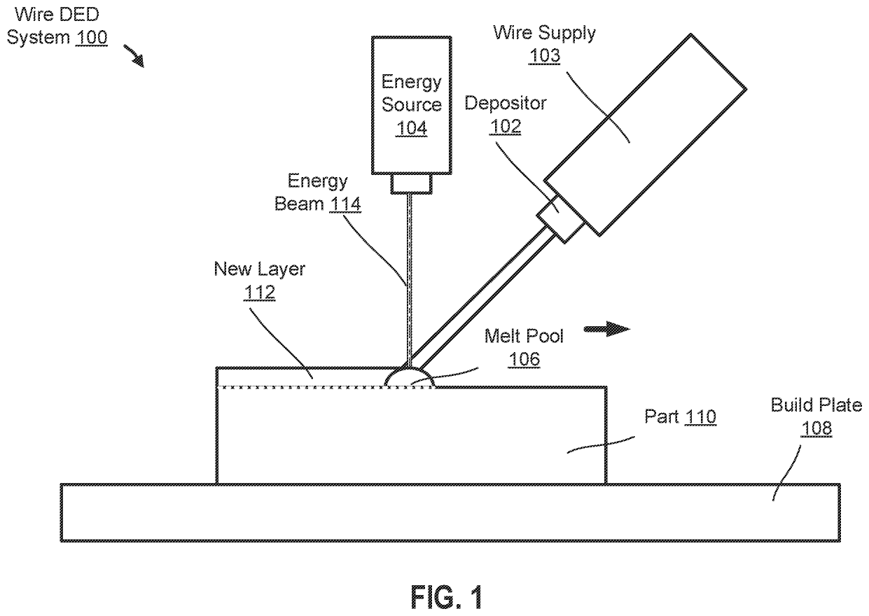

FIG. 1 illustrates an example wire DED system 100 for additive manufacturing using wire. Wire DED system 100 can include a depositor 102 that can deposit each layer by using freeform beads of wire from a wire supply 103 that can be progressively forged. System 100 also includes an energy source 104 (e.g., laser or electron beam source, or electric arc) that can generate heat to melt each layer of material upon deposition and form a melt pool 106, and a build plate 108 that can support one or more build pieces, such as part 110. The wire supply 103 in various embodiments may include a wire feedstock, which can be a roller that feeds the depositor 102 with wire for fusing by energy source 104.

The example of FIG. 1 shows wire DED system 100 after multiple layers of part 110 have each been deposited, and while a new layer 112 is being deposited. While the new layer is deposited, part 110 can remain stationary, and depositor 102 and energy source 104 can cross a length and width of the part while releasing wire and generating heat, respectively. Alternatively, depositor 102 and energy source 104 can remain stationary, and part 110 can move under the depositor 102 and energy source 104 instead to accomplish a similar layering. The energy source may generate an energy beam 114, a laser beam, or other source of heat to melt the deposited material for each layer. In some embodiments, a build plate 108 may be unnecessary, as the DED process is sufficiently versatile for use on existing parts that may already be mounted in place in another location.

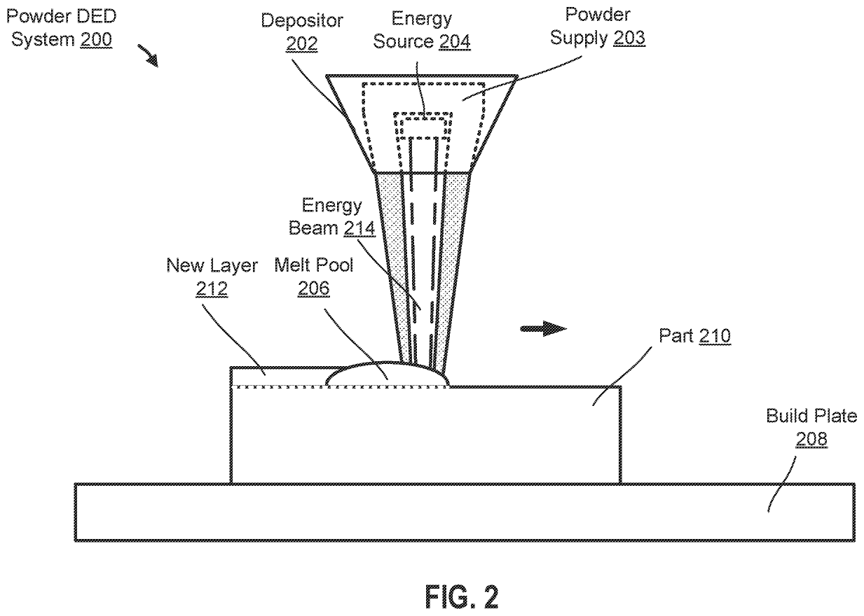

FIG. 2 illustrates an example powder DED system 200 for additive manufacturing using powder. Powder DED system 200 can include a depositor 202 that can deposit each layer of powder from a powder supply 203, an energy source 204 that can generate heat to melt each layer of material upon deposition on the part 210 and form a melt pool 206, and a build plate 208 that can support one or more build pieces, such as build piece 210. The example of FIG. 2 shows powder DED system 200 after multiple layers of part 210 have each been deposited, and while a new layer 212 is being deposited. While depositing the new layer, part 210 can remain stationary, and depositor 202 and energy source 204 can cross a length and width of the build piece while releasing powder and generating heat, respectively. Alternatively, depositor 202 and energy source 204 can remain stationary, and part 210 can be moved under the depositor and energy source instead to accomplish the same layering. This versatility in applying the layering in different ways is one benefit of DED. The energy source may generate an energy beam 214, a laser beam, or other source of heat to melt the deposited material for each layer. For simplicity, FIGS. 1 and 2 illustrate examples of the DED process without yet introducing the feature of in-situ forging. However, both DED systems in FIGS. 1 and 2 can be modified as described and illustrated herein to include concurrent forging capabilities.

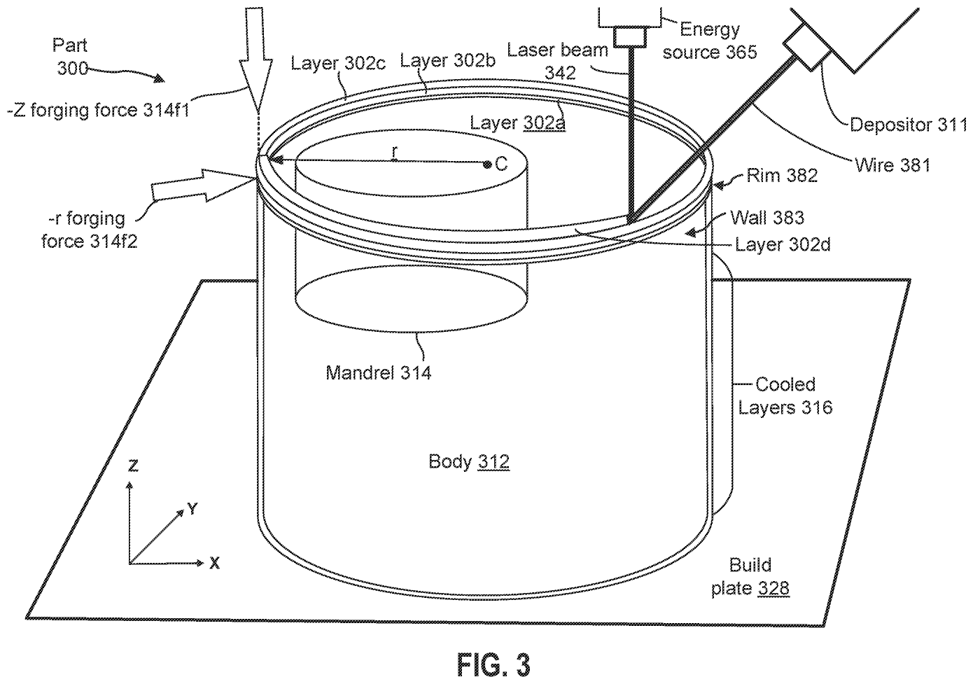

FIG. 3 is a diagram illustrating in-situ forging of a part 300 being additively manufactured using DED. The additional features of FIG. 3 and following figures can use the DED implementation described in FIG. 1, FIG. 2, or another DED-based print setup. While the part 300 shown in FIG. 3 is cylindrical in nature and the inner portion of part 300 is hollow, the geometry of the part is purely for descriptive purposes, and in practice, the part can have any geometry and can be partially or fully solid without departing from the scope of the present disclosure. The part can have other connections made using some other process, such as electrical connections or an electric circuit module, or these components may be added after the DED. Thus, while more complex build pieces may be used, the cylindrical part 300 is shown in FIG. 3 to avoid unduly obscuring concepts of the disclosure.

The DED part may be progressively forged in-situ using a mandrel 314, which refers to a section over which a material being forged is laid up or shaped. The in-situ forging may occur to the portions of the part 300 that are still cooling, as opposed to those portions that have already returned to thermal equilibrium. Referring to part 300, the lower part of the part 300 has generally had a chance to cool down, while the upper part still harbors temperature gradients due to the energy source 365. The forging process can take advantage of the thermal gradients near the surface to concurrently apply forging loads when this portion of the part 300 is most malleable and amenable to error correction and geometrical manipulation, depending on the objectives.

Build plate 328 may be used to support the part during DED, similar to respective build plates 108 and 208 of FIGS. 1 and 2. Build plate 328 may include any substrate material for supporting the part. If the part is an element of a larger structure, then DED may be performed on the part without a build plate, or with a modified build plate. Shown near the build plate 328 on the lower left are coordinate axes x, y, and z, which may be used by a controller or robot for positioning of the part. Other frames of reference are possible. For example, in this case, cylindrical or spherical coordinates may be more appropriate.

The cylindrical portion of the part shows center C of a cross-section of the cylinder body 312, with a vector r representing the radius and having an outward direction relative to the center C of the circle. The vector r and center C are not structures within the part 300. Instead, they represent reference frames which can be used by the energy beam source, depositor, and, if applicable, the positioning system (e.g., robotic arms) controlling the forging tools.

The part 300 is in a DED additive manufacturing process. A separate controller or processing system may be coordinating the DED process, the forging process, or both. In some embodiments, a controller may be coupled to the positioning systems controlling the DED based structures (e.g., the energy source 365 and the depositor 311) and the forging tools. In this way, an organized timing of operations can be carefully coordinated by a central controller.

Part 300 includes a potentially large plurality of individual layers formed from wire 381 that may be circumferentially applied via depositor 311. The controller may be coupled to the depositor, as well as energy source 365, for controlling the DED process. For example, part 300 includes layers 302a-d circumferentially applied around the rim 382 of the part. In various embodiments, the layers of wire may initially be deposited as beads and then progressively forged into a uniform geometry shortly after the wire is energized by the energy beam.

To avoid excessive content in FIG. 3, the forging tools are not explicitly shown but instead are represented by vectors 314f1 and 314f2, shown as large arrows. For example, arrow 314f1 represents a downward force component of a forging tool applied in the “minus z” (−z) direction. Arrow 314f2 represents a force applied by a forging tool in the “minus r” direction. The corresponding forging tools may apply forces in other directions, such as directions that are offset from the −z and −r arrows 314f1 and 314f2 by an angle. Similarly, the forging tools may adjust the duration and magnitude of the applied forces to achieve an optimal result.

FIG. 3 further shows mandrel 314, which in this example is applied to the inner portion of the rim 382 and is used oppose the application of forging force 314f2, as is consistent with forging in general. In various embodiments, the shape of rim 382 and the can be adjusted using different shapes of mandrel 314. FIG. 3 shows a hollow body 312 in which a mandrel can be positioned (e.g., by a robotic arm under controller guidance) in the interior, adjacent the walls near the current forging vectors. In other cases where the part 300 is at least partially solid, a custom mandrel may be 3-D printed or otherwise provided that accounts for the partially full shape of the part 300. Thus, a more complex mandrel shape may be designed and implemented in some embodiments. The mandrel may be printed or manufactured using conventional machining techniques instead of by 3-D printing.

A mandrel may also be provided that allows the forging tools to change select portions of the geometry of the cylinder. In various embodiments, a plurality of mandrels may be used in sequence to effect different geometric changes to the part. One example is a part where a need exists to close out or seal the ends of a long, substantially cylindrical section as at least partly shown by part 300 in FIG. 3. A simple disc-shaped mandrel is shown in FIG. 3.

The part 300 may include a body 312 as noted, a wall 383 that extends circumferentially around the part, and a rim 382, or top of the wall represented here by layers 302a-d. A hollow space in this example is present within the wall 383 of the body. In cases where a part is completely solid, the part may still be forged using the interior solid portion of the part to oppose the force of the forging tools, such that the interior solid portion acts, in a sense, like a mandrel.

In various embodiments, more than two forging tools may be applied to perform different operations on the part 300. For example purposes, an outline of the dual forging/DED technique may include one or more of at least the following steps.

Additive manufacturing. A top layer (e.g., 302d) may be applied across a portion of the circumference of the upper part 300. The layer 302d may be melted by the energy beam, after which it begins to solidify. The layer 302d may only cover part of the circumference because of geometry considerations as dictated by the CAD model, or instead, the design may contemplate interrupting the DED process to apply forging.

Forging. Radial forging/clamping loads (−r) may be sequenced with hammering loading (−z). For example, after a portion of the upper layer 302d has been deposited and fused and a particular temperature has been reached, e.g., as determined by a controller or sensor circuitry, the forging tools may sequentially or concurrently apply a −z forging force 314f1 along with a −r forging force 314f2. The application of these forces may be made one time or multiple times using a periodic cycle determined by the controller. For example, a first forging tool may apply a −z forging force 314f1 to the edge of layer 302d (as shown by the dashed line from arrow 314f1), followed immediately by a second forging tool applying −r forging force 314f2, and the cycle may repeat. In other examples, the 314f1 and 314f2 forces may be applied concurrently. While the forces 314f1 and 314f2 are shown as respectively orthogonal and radially inward, it will be appreciated that the magnitude and direction of application of the forces may vary based on various factors, including the type of material, the temperature, the desired geometry and objective, etc. In some arrangements, the forging may be used to strengthen the rim 382 and increase the material density. In other arrangements, the forging may be also used to change the geometry of the part 300 or to reshape the edge of the part 300.

It should be noted that a temperature sensor or thermometer may be maintained adjacent the part because the temperature of a region of the part may determine the optimal region to forge the part. In designing a forging process, often the forces are applied at a region of the part within a certain temperature range. This temperature range may be needed so that the part can be predictably forged. For example, the malleability of the print material is likely to depend on its temperature. In this embodiment, the region of forging can be changed such that the temperature within the forged region is maintained within a predetermined temperature range.

In addition to the importance of the temperature, the controller may keep track of the region of the part to be forged based on a position of where the print material is deposited by the DED. Typically, the most recently deposited print material is subject to an energy beam and thus should be where forging takes place in order to immediately address cracks and inclusions, and increase consolidation strength in the vertical direction to remove inter-layer consolidation problems. In various embodiments, the controller may determine the region of the part to be forged based on a position of depositing material, and thereafter changing that determined region to maintain a predetermined distance between the earlier region and the position of depositing material.

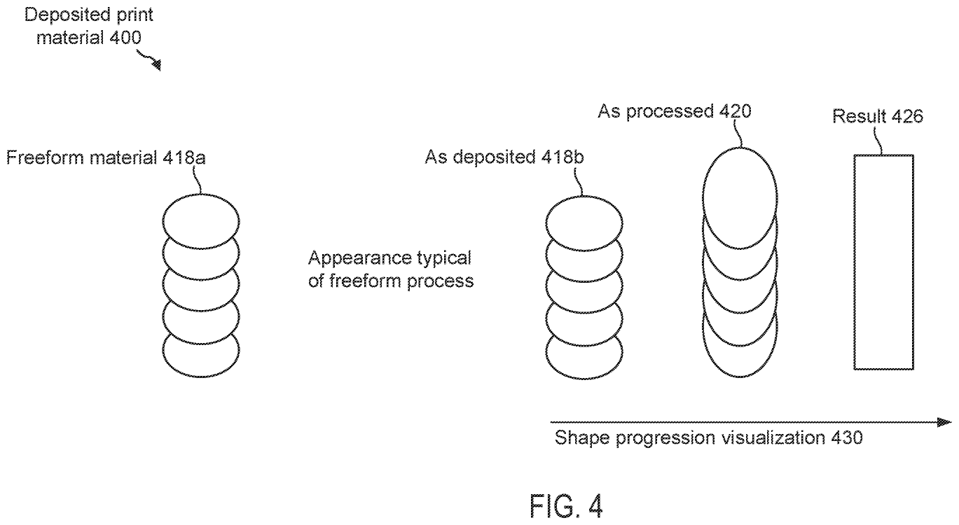

Order of operation. The order of operation of additively manufacturing part (e.g., fusing wire deposited on the rim 382) may vary depending on the type of part and the operation. With continued reference to FIG. 3, the circumferential weld may proceed in a piece-wise manner, interspersed with forging operations. For example, a DED process may involve adding these piece-like layers as deposited portions, and then progressively forging these deposited portions to progress the shape into a solid layer, as shown more clearly in FIG. 4. In various embodiments, the weld may proceed with only specific regions requiring reshaping or other operations through forging. In still other embodiments, including other parts having a flat surface, the DED operations may be performed until a single layer is completed, after which forging operations may commence. Once forging for that layer is complete, the next layer may be added. In some embodiments, the DED operations may be performed after some number or multiple of layers have been deposited.

In automated embodiments where temperature is closely monitored (e.g., using temperature sensors adjacent the part), the order of forging and printing may occur on the fly. That is, the controller may determine the order after printing has begun, based on the temperature of the deposited layers, the intended geometry of the finished part, or other factors.

FIG. 4 is a conceptual diagram illustrating a progression of freeform print material 400 into a solid structure during an in-situ forging process with DED. The material deposited during DED typically is shaped as freeform material 418a. For example, the freeform material 418a may represent material immediately prior to deposition of the various layers 302a-d in FIG. 3. The freeform material 418b is thereupon deposited. In some cases, each freeform bead of the material 418b may represent a separate layer (e.g., part of 302a-d ). In other cases, the freeform material 418 may be deposited as a single layer (e.g., layer 302d).

The as-processed material 420 may represent one or more layers of material at the edge of the cylinder. As shown by the shape progression visualization 430, the material 420 gets further processed as it is fused together by the energy beam 342. However, there may remain discontinuities in the as processed material, which may be formed together but in a less-than-uniform manner.

In various embodiments, progressive forging can apply vertical and horizontal forces to the material 420 against a mandrel. The application of the forces against the smooth mandrel in turn increases the isotropic nature of the material, and with the result 426 becoming a solid and homogenous portion of the material rather than a series of freeform beads with potential inclusions and inter-layering issues. Thus the combination of the fusing by the energy beam and the forging can substantially improve the material characteristics, including the uniform nature, of the material.

The forging instruments in an automated DED-forging process may be held by an effector. The type of forging instruments may vary depending on the objectives that the manufacturer is attempting to achieve—e.g., the properties or shape of the metal. Some forging instruments may be blunt to distribute the applied force across a greater area. Still other forging instruments may be curved. For example, the (x-y) forging element that acts in the −r direction in FIG. 4 may be include a similar curvature to that of mandrel 314, in order to help obtain a uniformly curved shape free of defects. Forging tools may include tongs, blades, hammers or hammer-like structures, and even rollers.

FIG. 5 is a top-down diagram of an example part 500 being forged with a roller-based forging tool, or outside roller 534. The part 500 may be a top view of the cylinder in FIG. 3. The −z forging tool is omitted so as not to obscure outside roller 534 from view. One advantage of roller 534 is that it can be quickly used to apply a force on the edge 511 of the part 500 such that the edge 511 can adopt the curvature of the inner mandrel 514. This embodiment may be especially desirable if the edge 511 is thinner than usual and the forging must be performed with delicacy. The outside roller 534 can also beneficially cover area on the edge 511 quickly, before lower temperatures return, since the robotic arm can quickly move the roller across the edge 511 and can repeat the task as needed until printing resumes.

The forging tools may include other features, such as integrated cooling channels to enable cooling of the workpiece if optimal performance requires faster drops in temperatures. In various embodiments, the integrated cooling may be present in the part being printed instead. Such channels may be beneficial if the part being printed is a larger solid piece that may need further time to cool.

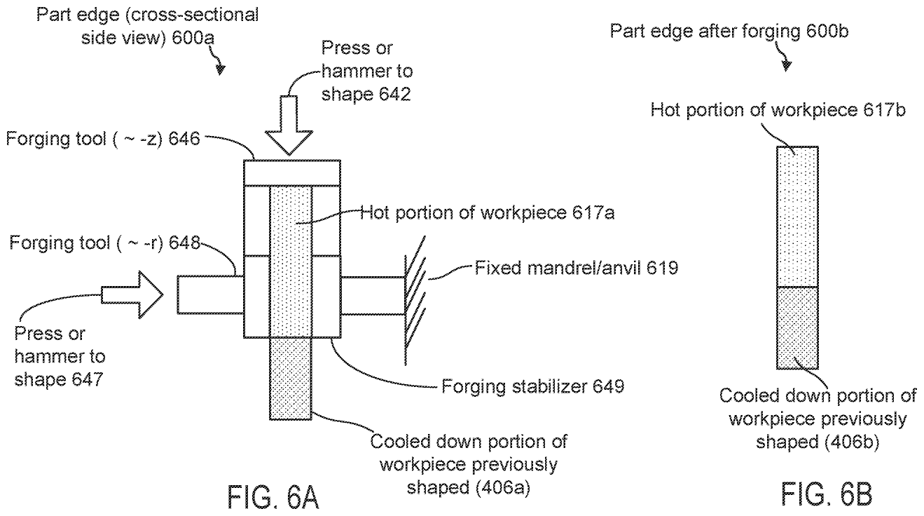

FIGS. 6A-B are cross-sectional views of a region of an additively manufactured part being forged using a combination of forging tools and a fixed structure. FIGS. 6A-B may be a zoomed-in representation of the cylinder edge of FIG. 3, this time with the forging tools shown. The edge of the cylinder is shown as a rectangle for simplicity. The edge constitutes the workpiece itself. The workpiece may refer to a portion of part 300 in FIG. 3, with scale exaggerated for clarity. For simplicity, the workpiece is divided into a cooled down portion 406a that was previously printed using DED and forged, and a hot portion 617a that is undergoing printing and forging.

The down forging tool 646 applies a force when necessary in the −z direction. The application of this force is represented by vector 642. In various embodiments, a robot may apply the downward force of a magnitude and at a time specified by a controller. Forging tool 646, being on top of the workpiece, is shown as having a downward “u” shape such that the force of vector 642 can be more or less uniformly distributed across the top edge of the workpiece. Another forging tool 648, which is oriented as a flat surface on the workpiece immediately below forging tool 646, may be configured to apply a concurrent (or periodic) force characterized by vector 647 in the —r direction.

Meanwhile, on the other side of forging tool 648 is a similar flat edge attached to a fixed mandrel. The flat edge acts as a forging stabilizer 649, since it receives various components of force from forging tools 646 and 648. In this example, the forging stabilizer 649 is directly connected to a fixed mandrel or anvil 619. Where the workpiece is a part of a cylinder as in FIG. 3, then the forging tool 648 and the forging stabilizer may be slightly curved to account for the cylinder curvature. The above configuration of forging tools and the forging stabilizer and mandrel are exemplary in nature, and the shape and type of tools to be used for the forging technique depend on the geometry to be obtained and the remaining objectives, such as removal of defects, etc.

After the cycle of forging is complete, the forging tools may be removed to allow the DED process to proceed, including the deposition and scanning of the materials. In an automated process, the respective forging robots may use a pattern of engaging and disengaging the workpiece until it is complete. FIG. 6B shows the workpiece after the robots disengage, e.g., to return to DED. The workpiece likely includes an increased cooled portion 406b since additional time has elapsed since the application of the energy beam to fuse one of the layers. The remaining hot portion 617b may be subject to additional deposition of layers if DED printing is still incomplete.

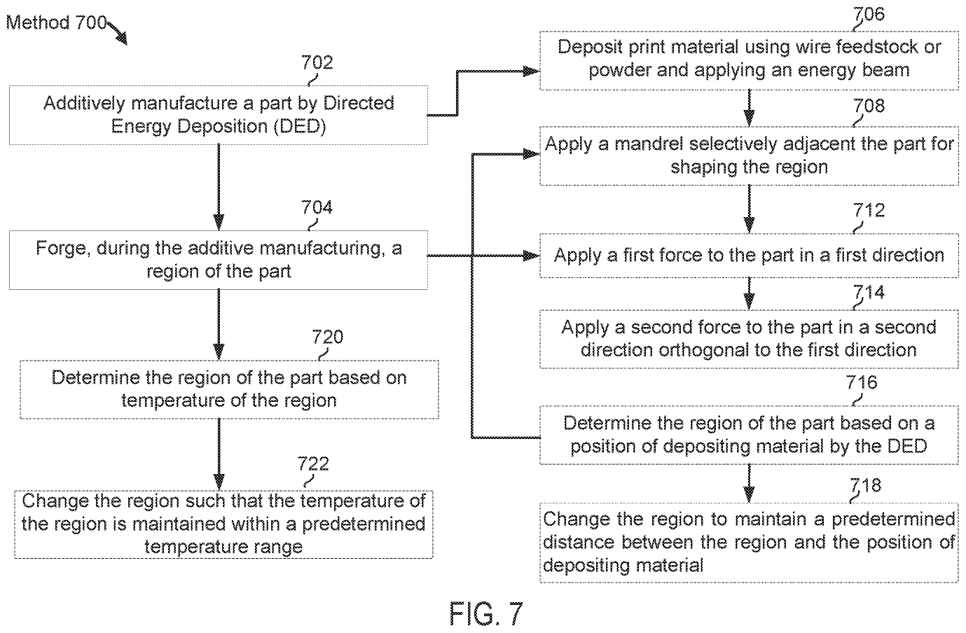

FIG. 7 is an exemplary flow diagram of a method for additive manufacturing using

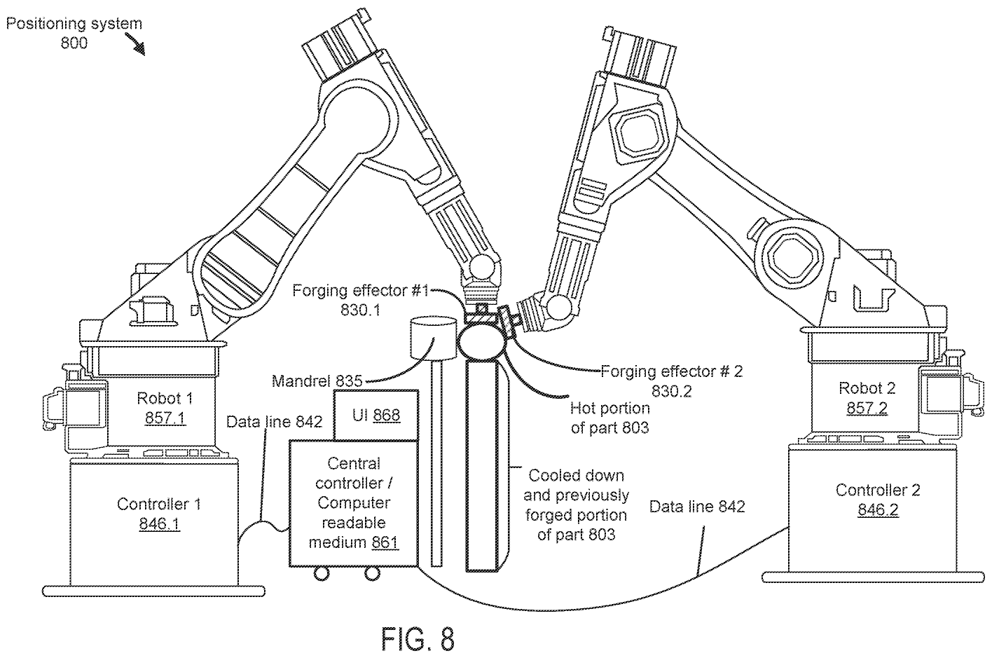

DED while concurrently forging the part. The described method may be performed manually or, in the various embodiments where part or all of the process is automated, the DED printing and progressive in-situ forging may be performed by one or more robots and separate equipment for depositing print material and fusing the material as described herein. In some embodiments, these procedures may be performed by one or more robots at an assembly cell, such as described, for example, in FIG. 8.

Referring first to 702, a part is in the process of being additively manufactured using DED. Step 702 may also include step 706, in which print material using wire feedstock or powder is deposited, and an energy beam is used to melt and solidify the area. It will be appreciated that the steps need not be performed in this order. For example, the in-situ forging may begin prior to application of the energy beam in some cases.

At 704, various forging tools and an anvil may be used to forge in-situ a designated region of the part pursuant to a set of design objectives. In various embodiments, the step of 704 may be broken down into additional steps. For example, after DED is performed on the part at 706, a mandrel may be selectively applied adjacent the part for shaping the region at 708. The forging may thereafter include applying a first force to the part in a first direction at 712, and applying a second force to the part in a second direction orthogonal to the first direction 714.

As noted, the forging may also involve using a temperature sensor near the workpiece or part to determine the region of the part to forge based on a temperature of the region, such as at 720. Because temperature is often a relevant criterion to enable the part to be forged in a predictable manner producing desired results, the controller at 722 may record and periodically change the region to be forged based on a temperature sensor such that the temperature of the region is maintain within a predetermined temperature range, determined prior to the DED build and based on a number of factors. This helps ensure that predictable results are achieved and desire effects are removed by the magnitude and direction of the applied forces on the material having the appropriate temperature range.

A further relevant criterion of forging is the position of the most-recently deposited material, as this is typically the area that is subject to an energy beam and that at some point will be conducive to being improved using the application of forging forces. For example, a controller at 716 may determine a region to forge the part based on a position of depositing material in the DED process. The controller may track this information for future forging steps. For example, the controller at 718 may change the region of forging such that a predetermined distance is maintained between the immediately prior region of forging and the present position where material is deposited. Using these different features can help the controller keep track of the optimal locations to perform in-situ forging and achieve a predictable result with an ideal geometry and removal of flaws.

FIG. 8 is a side view of an exemplary positioning system 800 using robots 857.1 and 857.2 for manipulating forging of a part during a DED process. Each robot in the embodiment of FIG. 8 has a local controller. Robot 857.1 includes controller 1 846.1. Robot 857.2 includes controller 2 846.2. Through the controllers 846.1 and 846.2, each robot is coupled to a central controller 861 via a data line 842. The central controller 861 may include a computer readable medium 861, which may be a central data repository or database for maintaining information. The central controller 861 may also be coupled to a user interface (UI 868) to enable manipulation and data retrieval.

Central controller 861 may in this embodiment be coupled via a data line 842 or other wireless network connection to robots 857.1, 857.2, and one or more additional robots. Central controller 861 may, based upon CAD models and compiled instructions, coordinate the assembly of a component using DED and in-situ forging. The local controllers 846.1 and 846.2 may receive the commands from the central controller and may proceed to move its respective forging effector #1 (830.1) or forging effector #2 (830.2) and apply necessary forces at the appropriate positions to effect progressive forging. In some embodiments one of robots 1 or 2 may also control positioning of the mandrel 835. In other embodiments, this positioning can be done by another robot or machine.

As shown in the embodiment of FIG. 8, a solid block is being printed in rectangular fashion for illustrative purposes. The DED equipment is also present (see, e.g., FIG. 1) but is omitted in this figure in order to show the controller hierarchy and the use of the robots 1 and 2 (857.1 and 857.2) to control the application and direction of force with its respective effector # 1 (830.1) or #2 (830.2). The forging effectors 830.1 and 830.2 are acting on the hot portion of part 803b which, unlike the cooled down and previously forged portion of part 803a, is mis-shapen after a cycle of DED.

While the embodiment of FIG. 8 shows a central controller 861 such as a server and corresponding database, this need not be the case and in other embodiments, one of the robot's controllers (e.g., controller 846.1) may instead act as a central controller, or tasks may be delegated in a different manner. Where additional robots are present for controlling the DED procedures, they may have their own controllers and different end effectors for applying print material. The energy source and the print source may be part of a discrete machine, or the components of the machine may in other cases be operated by robots.

Using controllers 846.1 and 846.2, the robots can position their forging tools during the additive manufacturing. Each robot has a robotic arm that can be used to help apply the necessary amount of force to properly conduct the forging process. Positioning of the forging may be based on the temperature of regions of the part 803 (as measured by a temperature sensor), the last regions of DED deposition on the part 803, or on other factors. In various embodiments, the positioning system can be configured to change the position of the forging tools such that a predetermined distance is maintained between the region and the position of depositing material.

The previous description is provided to enable any person skilled in the art to practice the various aspects described herein. Various modifications to these exemplary embodiments presented throughout this disclosure will be readily apparent to those skilled in the art. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A method, comprising:
additively manufacturing a part by directed energy deposition (DED); and
forging, during the additive manufacturing, a region of the part.

2. The method of claim 1, wherein the forging further comprises applying a mandrel selectively on an inner region of the part for shaping the region of the part.

3. The method of claim 1, wherein the additively manufacturing comprises depositing print material using wire feedstock.

4. The method of claim 1, wherein the forging further comprises:
applying a first force to the part, wherein the first force is in a first direction; and
applying a second force to the part, wherein the second force is in a second direction orthogonal to the first direction.

5. The method of claim 4, wherein the first direction is normal to deposited layers of print material.

6. The method of claim 4, wherein the second force comprises a rolling force.

7. The method of claim 5, wherein the second direction is normal to a completed surface of the part, the completed surface being a surface of the part after completion of the additive manufacturing.

8. The method of claim 1, wherein the forging comprises determining the region of the part based on a position of depositing material by the DED.

9. The method of claim 8, wherein determining the region of the part comprises changing the region such that a predetermined distance is maintained between the region and the position of depositing material.

10. The method of claim 1, wherein the forging comprises determining the region of the part based on a temperature of the region.

11. The method of claim 10, wherein determining the region of the part comprises changing the region such that the temperature of the region is maintained within a predetermined temperature range.

12. An apparatus, comprising:
a directed energy deposition (DED) system configured to additively manufacture a part; and
a forging tool configured to forge a region of the part during the additive manufacturing.

13. The apparatus of claim 12, wherein forging tool is configured to forge the region of the part against a solid body.

14. The apparatus of claim 13, wherein the solid body is arranged opposite to the forging tool during the forging.

15. The apparatus of claim 13, wherein the solid body includes a mandrel against which the region of the part is forged.

16. The apparatus of claim 15, wherein the mandrel is co-printed with the part.

17. The apparatus of claim 12, wherein the forging tool is configured to forge an outer region of the part, such that an inner region of the part provides a force opposing the forging.

18. The apparatus of claim 12, wherein the forging tool comprises a positioning system configured to position the forging tool during the additive manufacturing.

19. The apparatus of claim 18, wherein the positioning system comprises a robotic arm.

20. The apparatus of claim 18, wherein the positioning system is configured to position the forging tool based on a position of depositing material by the DED.

21. The apparatus of claim 20, wherein the positioning system is configured to change the position of the forging tool such that a predetermined distance is maintained between the region and the position of depositing material.

22. The apparatus of claim 18, wherein the positioning system is configured to position the forging tool based on a temperature of the region.

23. The apparatus of claim 22, wherein the positioning system is configured to change the position of the forging tool such that the temperature of the region is maintained within a predetermined temperature range.

24. The apparatus of claim 22, further comprising a temperature sensor configured to sense the temperature of the region.

25. The apparatus of claim 12, further comprising a controller configured to control a rate of application of compressive force of the forging tool.

26. The apparatus of claim 25, wherein the controller is configured to control the rate of application of compressive force based on a geometry of the region, a timing of cooling of the region, or a time of a depositing of a previous layer of material.

27. The apparatus of claim 12, wherein the forging tool is configured to provide a first compressive force on the part.

28. The apparatus of claim 27, wherein the forging tool is further configured to provide a second compressive force on the part, the first and second compressive forces collectively configured to remove print defects.

29. The apparatus of claim 28, wherein the print defects comprise at least an oxide production, an inclusion, a lap, a shut, or a part misalignment.

30. The apparatus of claim 12, wherein the forging tool is shaped to match a desired shape of the region of the part being formed.
